(19) United States
(12) Patent Application Publication
(10) Pub. No.: US 2006/0064316 A1
(43) Pub. Date: Mar. 23, 2006

(54) Interactive computer system in the field of family and children adoption services

(76) Inventor: Keith M. Wallace, Evansville, IN (US)

Correspondence Address: Gary K. Price, Esq.;Bowers Harrison, LLP, 25 N.W. Riverside Drive, Evansville, IN, 47706-1287, US

(21) Appl. No.: 11/233,964

(22) Filed: Sep. 23, 2005

Related U.S. Application Data
(60) Provisional application No. 60/612,210, filed on Sep. 23, 2004.

(51) Int. Cl. G06Q 99/00

(52) U.S. Cl. 705/1

(57) ABSTRACT

An event-triggered computer system and method to facilitate the organization, maintenance, and processing of information resources in the field of family and children adoption services, as well as the distribution and communication of such information over the Internet. The system uses a number of relational databases that include a unique identifier, and an association between the identifier and each of the system's databases. The system selectively transmits messages to the user and stores the message to provide a history of correspondence transmitted. The system further can receive a message from user, parse content of the message, and store the message to provide a history of correspondence transmitted. The system further includes a plurality of templates for providing selected messages to the user.

### CROSS REFERENCES TO RELATED APPLICATIONS

U.S. Provisional Application for Patent No. 60/612,210, filed Sep. 23, 2004, with title “Event Triggered Notification Over a Network” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

This invention relates generally to computer systems used in communication of information in large distributed networks such as the Internet and, in particular, to an object-oriented approach for processing and communicating such information in the field of family and children adoption services.

2. Brief Description of Prior Art

With the advances in computer technology and the advent of globally connected computing networks such as the Internet, vast amounts of information are now readily available. Using a computer, one can access and receive information stored in remote data storage devices and communicate with other computers connected in a communications network. Many computer users actively access and communicate information via a communications network throughout the day. This information is typically stored in various storage mediums in the communications network as electronic files.

Given the vast amount of information generated on the Internet, a user may be notified whenever particular information becomes available. There are several notification mechanisms currently in use for informing users of particular events. One such method uses e-mail as a notification mechanism. There are several well-known examples of websites which allow users to receive e-mail alerts for various pre-defined events.

The computer system as described herein is designed particularly in the field of family and children adoption services however as should be understood, the system can also be used in other applications. In the field of family and children adoption services, there is little available in software application systems. “Adoption Services” as used herein shall mean the process of events necessary to complete an adoption process namely, from the time an applicant files an application for adoption to the time the adoption process is finally completed. As known in the art, Adoption Services can be a very lengthy process consumed with pre-defined events. Adoption Services generally require an assigned caseworker to continuously monitor and manually maintain the adoption process from beginning to end. It should be noted that the process may differ from state to state within the United States, and certainly differs with foreign countries. As such, monitoring, controlling and successfully processing Adoption Services can not only be time consuming for the assigned caseworker, but also requires organizational skills in order to accurately apply the appropriate process with the selected state or country.

Adoption Services which do not require the full-time services and monitoring of an assigned caseworker is not known.

There is consequently a need for a computer system that provides constructive assistance to the assigned caseworker of Adoption Services, will control and process information data, monitor and execute pre-defined events of the Adoption Services, and provide a notification mechanism which allows real-time message communications and notification in the field of Adoption Services. The present invention seeks to meet this need.

As will be seen from the subsequent description, the preferred embodiments of the present invention overcome shortcomings of the prior art.

### SUMMARY OF THE INVENTION

The present disclosure is directed to a computer system and corresponding method to facilitate the organization, maintenance, and processing of Adoption Services, as well as the distribution and communications of information over the Internet. The system in addition to maintaining the flow of events during the Adoption Services, further monitors the type and content of electronic files, such as e-mails and other sources for content that are accessed, received, or transmitted. The system then analyzes this information and determines keywords or categories of information included in each content source.

The analysis is based on guidelines provided within the system. Various standard and custom templates are generated by the system providing detailed information about the associations between a certain keyword and one or more content sources where the keyword may be found. The template may then be used to organize or retrieve information based on other classifications.

The system generally comprises a data storage device and program module stored on the storage device. The program module is operable upon execution to display a graphical user interface having a number of user-selectable items. Each of the user-selectable items is associated with a different data set. The data sets are each representative of a different category and comprise a number of user-selectable links to different information resources. For example, one of the data sets can be operable upon execution to enter new data records on the storage device. A second data set can be operable for modifying or deleting data records stored on the storage device.

Another data set can be operable in response to notifications to select the informational data to be displayed from among a larger amount of informational data, this data set can be further operable to store statistical or historical data regarding the display of selected informational data.

In addition, the system further includes user specific maintenance and organization of files and resources represented by the user-selectable links contained within the program module.

In accordance with another aspect of the invention, the system uses e-mail as a notification mechanism. In particular, the system generates pre-determined messages from keywords and records previously entered and from such information generates a relevant notification to a user. The message is then forwarded to the user via e-mail notification. Record of each e-mail transmission, including date of transmission, and content is then maintained on the data storage device and linked to the record profiles of the user.

### BRIEF DESCRIPTION OF THE DRAWINGS

FIG. 1 is a diagram of a method of accessing one or more content sources, in accordance with one or more embodiments of the present invention, an interactive computer system in the field of family and children adoption services.

### DESCRIPTION OF THE PREFERRED EMBODIMENT

Event-triggered application software and notification over a network, according to one or more embodiments of the present invention, facilitate and provide electronic services for processing in the field of family and children adoption services. Selected content, such as keywords, included in the information sources, also referred to herein as content sources are classified and stored in a database. Stored also in the database are program models that include actionable checklists of pre-defined events relative to

Adoption Services as previously defined. Such pre-defined events to facilitate the construction, maintenance and processing of each applicant's record, as well as controlling the flow of processing each applicant's record for Adoption Services.

As used herein, “applicant” shall mean the applicant for Adoption Services. “Administrator” shall mean the administrator of the system. The Administrator can access the system to alter, delete, or add content, selection or display structure or content, presentation, authorization/de-authorization of users, and other operations. “Caseworker”, as used herein, shall mean the caseworker assigned by the adopting agency to an applicant for Adoption Services. “User” can mean either the applicant or caseworker using the system.

The terms “electronic services” and “services” are also used interchangeably throughout this patent document. The services provided by the system of this invention, in one or more embodiments, are provided by an on-line service provider. A “service provider” is an entity that operates and maintains the computing systems and environment, such as a server system and architectures that enables the delivery of information. Typically, a server architecture includes the infrastructure (e.g. hardware, software, and communication lines) that stores and offers the electronic or on-line services.

The system generally includes a central operations unit, such as a computer server having a plurality of communication channels connected thereto. The server includes a server processor, storage, and input/output. The server should be capable of storing, accessing and distributing computer applications, data, video, and audio. The server should further be capable of handling multiple terminals associated with multiple, simultaneous users. The server stores or accesses data records that may include digital computer records, programs, and/or applications, to a user located at a user terminal. A user thus accesses the server by means of a user terminal, which communicates through at least one communications channel. As used herein, the user terminal is defined as one or more components that either singly or together provide both input and output with the server. Therefore, the user terminal may be a computer which can both receive and transmit data or commands to the server over a single communications channel.

The storage primarily includes a program memory that can include a user database, an applicant database, a cases database, a phase database, an actions database, a documents database, and a content media storage. In particular, the applicant database is linked to the cases database using software means known in the art; the cases database is linked to the phase database; the phase database is linked to the actions database; and the actions database is linked to the documents database and content media storage. Other databases may be added to the storage sector of the system in order to store further information, and to enhance the capabilities of the system. Some databases may be eliminated or consolidated with the storage of the system and still be within the scope of the described invention.

Working together, the application software and defined system databases act as a single software application system that provides the computer user with a fully integrated computer system in the field of family and children adoption services. It should be noted that the storage, as well as the processor, utilize in various manners a permanent memory (commonly termed “ROM”), a temporary memory (commonly known as “RAM”), and a writeable/re-writeable memory, as is readily known to one skilled in the art. The processor may direct the accessing of the materials stored in the ROM databases, and the materials are then temporarily stored in the RAM. As is known in the art, the ROM may be a hard disk, a CD-ROM, or other permanent digital recording means, as are known in the field of the art. The program memory stores programs of content sources, and access the content storage and content selection database for data relevant to the programs of content sources in program memory.

The user database identifies and recognizes permitted users of the system, and categorizes available programs as well as databases available to the user, as well as options available to the user at various times during a session. In this regard, the user database recognizes and stores certain parameters and information regarding the access and use by users.

The applicant database identifies and recognizes data information relating to applicants of Adoption Services including name, address, married status, profession, gender, and the like.

The cases database identifies and recognizes case data information relating to the Adoption Services. For example, the cases database identifies for example, the agency that prepared the home study for an applicant during the adoption process, the assigned caseworker for the Adoption Services, as well as the preferred country of adoption, preferred gender and age of child the applicant(s) desire to adopt.

The phase database identifies in general, the various stages of the Adoption Services. In particular, the phase database identifies the start-date for the Adoption Services, the projected end-by date, as well as various benchmarks during the Adoption Services for the selected country or state.

The actions database identifies and recognizes actions to be taken during each phase during the Adoption Services, and generates checklists to be completed during the present phase. The actions database further recognizes and records when a particular action is initiated, is completed, as well as recording and communicating with the user during the course of a particular phase. In this regard, the actions database communicates with the document database to generate a selected report or document during phases of the Adoption Services. The documents database further identifies and monitors the type and content of electronic documents such as emails for content that are accessed, received, or transmitted. In this regard, the documents database includes keywords and content sources to identify and generate incoming and outgoing correspondence. The documents database further stores on the database correspondence generated and received during the Adoption Services.

As such and as described above, an applicant for adoption will have a record (“Applicant's Record”) in the applicant database identifying that information, inter alia, described above. Applicant's Record will have a link to the cases database identifying relevant information for that applicant. In particular, when an Applicant's Record is initially generated, the system assigns the Applicant's Record a unique identification number (“ID”) which acts as a logical link or association between the system's databases. As such, the system's databases, in accordance with one aspect of the system, are relational databases that include an ID, and an association between the ID and each of the system's databases. In application, a user will initially input required applicant information in the applicant database in order to create a record for the applicant. The user may also input preference information of the applicant for example, the preferred country of adoption, the preferred gender, age, etc. so that a linked record in the cases database is generated. Once the information for the applicant is entered, the Adoption Services process is initiated and the system generates records linked to the applicant in the relevant system's databases including the phase database, actions database, and documents database.

As will be demonstrated, the system provides a caseworker access to the system in order to input, update and/or remove information and data relating to an Applicant's Record, as well as to the system's process or application. For example, in a family and children's adoption service application, the caseworker may be required to modify critical dates (primarily in the phase and actions database) relating to the adoption and post-adoption process. The system provides access to each of the various databases that relate to the system's application. In addition, the system provides an applicant access to selected information of the Applicant's Record in order to view the status of the Adoption Services, or to respond to action requests generated by the system.

In application, a user is prompted to log in via the terminal or interface with the system. When a user accesses the system, the system verifies the identification of the user and/or location. The user database determines whether the user is permitted access to the system. The user is then prompted to select an option or make a content selection.

The content selection database communicates to the user database to ensure that access is permitted to the desired content and to determine what selections are made available to the user for the content selection.

A caseworker can elect for the system to access all cases (or records) that the caseworker is assigned, or those records assigned to the caseworker that requires action. The relevant records and information is then accessed to communicate and present the content, for viewing and/or modification.

In the case where the caseworker directs the system to access those records assigned to the caseworker, the system's preferred method is often referred to as “polling” wherein the system polls the system's relevant databases (the cases database in this example) for those records in which the caseworker is listed as the caseworker. Likewise, to access relevant records that require action, the system polls the system's relevant databases (the phase database and actions database in this example) for critical dates and information. In the preferred embodiment, this method of polling relevant databases for critical dates and information is performed frequently, if not daily. In this regard, the polling is being done by an application running automatically on the system, without any intervention by the caseworker. Such polling schemes overcome the problem of user intervention by pulling information automatically on a periodic or controlled basis.

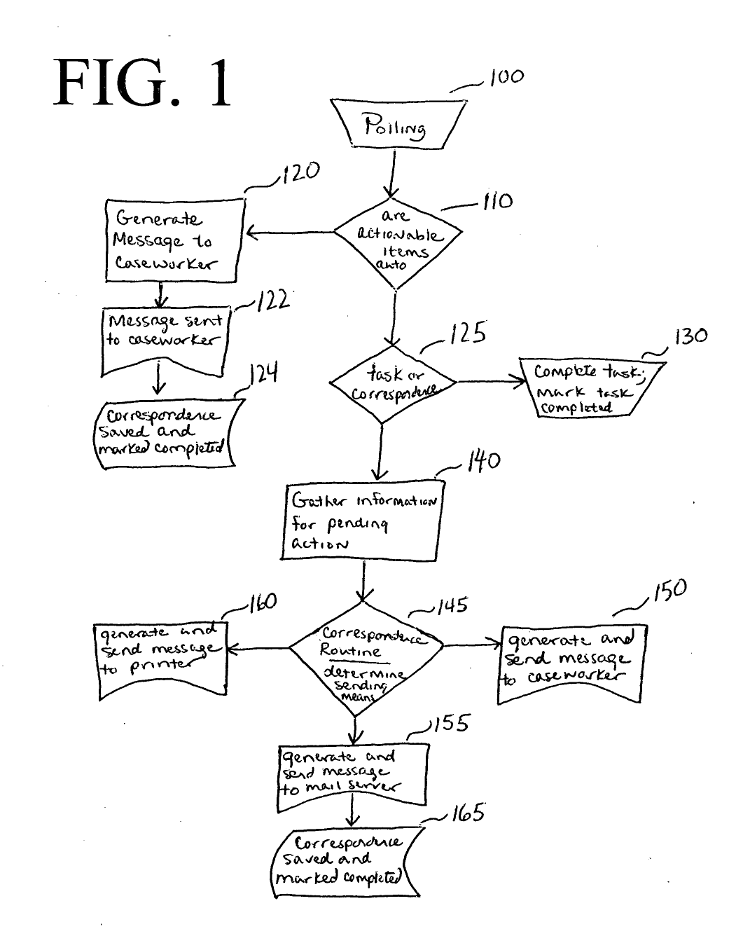

To generally describe this exemplary embodiment, references are now made to FIG. 1. At step 100, the application software polls the actions database for actionable items that are not marked as completed having a check date equal to the system's current date. At step 110, the system reviews an actionable item to determine whether such action is automatic or requires assistance from the caseworker. If the actionable item requires caseworker assistance, at step 120 a message is generated to the caseworker identifying the actionable item that requires the caseworker's assistance. At step 122 the system sends the message to the caseworker and, at step 124 the correspondence sent is saved and marked on the actions database as completed. If the actionable item can be acted on automatically by the system, at step 125, the system determines whether the actionable item is a task or correspondence. If a task, at step 130 the system completes the task and marks the task completed in the actions database. If correspondence, at step 140 the system accesses the required databases using the Applicant's Records ID to gather required information needed for the pending action. At step 145 the system executes the system correspondence routine and determines whether the information to be forwarded is to be sent in printed form, by email, or requires intervention by the caseworker. If intervention by the caseworker is necessary, at step 150 the system generates a message to the caseworker identifying the relevant correspondence. If by email, at step 155 the system generates the message and sends the message to the mail server. If the item is to be printed, the application gathers the information and forwards the information to the system's printer. At step 165, the correspondence either sent to print, email or required intervention is saved and marked on the actions database as completed.

An alternative method for notification is based on a “pull” technology where the caseworker explicitly pulls or selects records that require action. This is the most elementary notification mechanism. With this method, the caseworker can purposefully select an Applicant's Record in order to perform an action as described above.

The system includes notification means that generates and forwards flagged messages preferably over network communications such as electronic mail (e-mail) for immediate action or notification. Other methods for notification that are known in the art include transmitting an alert over telephone, facsimile, or printing a report that is delivered via U.S. mail. For each notification transmitted, the actions database accesses the documents database that generates a record of such transmission that can include the message transmitted, the date of transmission, as well as the method of transmission. The record is stored and provides a history of correspondence transmitted to each end-user.

In another embodiment of the system, application software is implemented to monitor a user's interaction with the system. Application software, for example, parses content of one or more communications such as e-mail messages sent to the system by the user. The application software also parses the content of other documents created, edited or viewed by the system or the user, for example. Depending on the type of content source parsed, application software searches for and records certain data in the system's documents during or after user access. Again, the stored record further provides a history of correspondence transmitted.

For example, if the system receives an e-mail message or opens an e-mail message from an applicant, application software may parse the heading and the content of the e-mail for the name of the sender, the time and date the message was sent, the subject heading of the e-mail, and address of any other recipients of the e-mail. In addition, the application software may parse the content of the e-mail for commonly used words or phrases that most frequently appear in the e-mail. Application software may be implemented to analyze the content of the message and select or recommend one or more keywords that summarize or relay the subject matter of the message.

One or more templates are implemented, in accordance with one or more embodiments of the invention to provide selected messages to a user. A template can be implemented based on the content sources of selected user records. For example, in one embodiment, the content sources may be grouped in particular categories, for example, based on what phase the Adoption Services is currently operating, or what action is required so that a relevant template is selected based on the topic included in the content source. Other grouping or classifying schemes may be used or implemented as desired.

### EXAMPLE 1

Creating and Sending Responses to an Adoption Inquiry.

A user accesses the system and is prompted to enter family information in the system. This system allows the user to enter the name, address, phone number, e-mail address, and gender of the person making the inquiry (“applicant”) and uses this information to search the user database for matches. If no pre-existing family match is found, the system creates an Applicant's Record for the applicant. The system generates the Applicant's Record with the information provided by the user and marks the Applicant's Record in the phase database as a “Prospect Phase family,” and activates a “Received Inquiry” checklist item in the actions database. The system's automatic marking of the checklist item triggers a series of events as follows: (1) a letter (the “first correspondence”) acknowledging the receipt of the inquiry is generated by the system and forwarded to the correspondence routine of the system, i.e. print, e-mail, or required intervention by the caseworker as previously described. The correspondence is then appropriately forwarded to the applicant; (2) approximately seven (7) days after the first correspondence is sent to applicant, the system generates a reminder, or actionable task for the caseworker assigned. The reminder notifies the caseworker that it is time to contact the potential adopting applicant to make sure applicant received the first correspondence and to answer any questions applicant may have. The reminder will continue to be scheduled daily until the caseworker updates the Applicant's Record indicating that the contact has been made; (3) approximately twenty (20) days following the sending of the first correspondence a follow-up letter is automatically generated to the applicant encouraging applicant to contact the agency if they have any questions; (4) approximately the fiftieth (50) day following the first correspondence, a second follow-up letter is generated by the system and e-mailed, when appropriate, to the Applicant; (5) approximately the one hundred seventieth (170) day following the sending of the first correspondence, a final follow-up letter is generated to the applicant; (6) approximately the three hundred sixty-fifth (365) day after the first correspondence, a final task is generated to the caseworker to remind the caseworker to contact the applicant one last time; and (7) the applicant's adoption process is automatically marked as deleted.

In the event during the above-cited process, the applicant responds and requests to continue the Adoption Services, the Applicant's Record enters the “Application Phase” and a new series of actions begin. This action will cause the system to dismiss any future scheduled reminders and letters regarding this item.

### EXAMPLE 2

Receipt of Dossier

Once the adoption agency receives a dossier document for an applicant, the caseworker connects to the system and updates the Applicant's Record that the dossier has been received by the agency. The system then automatically updates the Applicant's Record as entering the “Dossier Phase” of the adoption. The entering of the Dossier Phase automatically triggers a series of actions. The following represents the dossier steps regarding the process for adopting from Guatemala (obviously, the process varies by county): (1) a letter acknowledging the receipt of the dossier is generated and forwarded to the system's correspondence routine to send to the applicant. The system automatically flags the Applicant's Record that the dossier letter has been sent. The system, in generating the correspondence, examines a number of items such as whether the applicant is single or married, which state the applicant resides, as well as other such information in order to determine what attachments must be included with the correspondence. Again, once the correspondence is sent the system automatically makes note of it by marking the appropriate checklist items as complete. Further, a copy of the letter is stored in the applicant's contact log. In the event the dossier has been reviewed and approved by the adopting agency caseworker prior to the correspondence being generated the caseworker can mark the corresponding checklist item “Dossier Reviewed”, which prevents the initial dossier correspondence and attachments from being generated; (2) approximately fifteen (15) days after the Dossier Received checklist item is marked as active, a follow-up letter is generated by the system and forwarded to the system's correspondence routine to be sent to the applicant; (3) approximately thirty (30) days after the Dossier Received Checklist item is marked as active, a second follow-up letter is generated and forwarded to the system's correspondence routine to be sent to the applicant; (4) approximately forty-five (450) days after the Dossier Received checklist items is marked as active, a third follow-up letter is generated and forwarded to the correspondence routine to be sent to the applicant; and (5) follow-up letters continue to be automatically generated by the system and forwarded to the applicant approximately sixty (60) days after the Dossier Received checklist item is marked active, approximately seventy-five (75) days after the Dossier Received checklist item is marked active, approximately ninety (90) days after the Dossier Received checklist item is marked active, approximately one hundred five (105) days after the Dossier Received checklist item is marked active, approximately one hundred twenty (120) days after the Dossier Received checklist item marked active, approximately one hundred thirty-five (135) days after the Dossier Received checklist item is marked active, approximately one hundred fifty (150) days after the Dossier Received checklist item is marked active, approximately one hundred sixty-five (165) days after the Dossier Received checklist items is marked active, and approximately one hundred eighty (180) days after the Dossier Received checklist item is marked active. The stated correspondence and follow-up correspondence generated by the system can be update letters to provide the applicant a status report on the adoption process while they wait for the referral of their potential adoptive child. If during the process the family receives a referral for a child, the caseworker will enter the Applicant's Record, select the appropriate “Received Referral” checklist item and the system will cease to process the above-described follow-up letters.

### EXAMPLE 3

Traveling to the Country and Immediately After the Applicant Returns

The caseworker connects to the system and marks the “Departure to Country” checklist item. Once the Departure Checklist item is marked, various actions associated with the specific country are required. Again, the following sequence of events will outline the process as it applies to Guatemala; (1) a letter is generated by the system welcoming the applicant home and forwarded by the system to the correspondence routine to send to the applicant. With the correspondence generated, the system determines and chooses between a number of options in determining documents that are required to be included with the correspondence. The determination is made by examining such items as whether the applicant is single or married, what state the applicant resides, and a number of other options. Once the correspondence is forwarded to the applicant, the system automatically makes note of it by marking the appropriate checklist. An entry is further made into the Applicant's Record noting that the letter was generated and a copy of the letter is stored; and (2) the system generates and forwards a satisfaction survey and relative post adoption information to the system's correspondence routine to be sent to the applicant.

Once the applicant returns from the country with the adopted child, the caseworker connects to the system and marks the “Returned Home” checklist item of Applicant's Record. The system then automatically places Applicant's Record in the “Post Placement Phase” and the following actions take place: (1) required letters are generated containing additional information regarding the applicant's adoption and forwarded to the correspondence routine to be sent to the applicant. Along with the correspondence, the system determines and chooses as to what additional documents are required as attachments to the correspondence. Once the correspondence is sent, the system automatically makes note of it by marking the appropriate checklist item as complete. An entry is made in the applicant's contact log noting that the letter was generated and a copy of the letter is stored; (2) approximately five (5) days after the applicant returns home, a second letter is generated to again welcome the applicant home and offer additional support for the post-adoption process; (3) approximately ten (10) days after the applicant arrives home, the system generates an actionable task reminding the caseworker to call the applicant to follow-up on the any post-adoption questions; (4) approximately one hundred twenty days (120) days following applicant's return home, the system generates correspondence reminding the applicant the applicant of upcoming post-adoption report that will be due at the approximate six (6) month time mark; (5) approximately one hundred fifty (150) day following applicant's return home, the system generates a correspondence reminding the applicant of the upcoming post-adoption report that is due at the six (6) month time mark; (6) approximately one hundred eighty days (180) days following applicant's return home, the system generates a follow-up letter again reminding the applicant of the upcoming post-adoption report; (7) approximately three hundred (300) days following the applicant's return home, the system generates a letter reminding the applicant of the upcoming post-adoption report that will be due at the twelve (12) month time mark; and (8) approximately three hundred thirty (330) days following the applicant's return home, the system generates a follow-up letter reminding the applicant of the upcoming post-adoption report that is due at the twelve (12) month time mark.

If the six (6) month post-placement report is returned, the caseworker connects to the system and checks the “Six-Month Post-Placement Report Completed” checklist item of Applicant's Record. This action will cause the system to dismiss any future scheduled reminders and letters regarding this item. If the-twelve (12) month post-placement report is returned, the caseworker connects to the system and checks the “Twelve-Month Post-Placement Report Completed” checklist item of the Applicant's Record. This action causes the system to dismiss any further scheduled reminders and letters regarding this item.

Although the description above contains many specificities, these should not be construed as limiting the scope of the invention but as merely providing illustrations of some of the presently preferred embodiments of this invention. Further, it will be obvious that embodiments described may be varied in many ways. Such variations are not to be regarded as a departure from the spirit and scope of the invention, and all such modifications as would be obvious to one skilled in the art are intended to be included within the scope of the present invention.

Thus the scope of the invention should be determined by the appended claims and their legal equivalents, rather than by the examples given.

I claim:

1. A method for organizing, maintaining and processing information resources in the field of family and children adoption services, the method comprising the steps of:
polling the system's database for actionable items having a check data equal to a system's data,
determining whether the actionable items is an automatic action or a caseworker's task,
completing the automatic action marking the actionable item on the system's database as completed.

2. The method of claim 1, further including the step of transmitting notification to said caseworker of said actionable item.

3. The method of claim 2, comprising the steps of: (1) gathering information from the system's database for the actionable item, (2) determining a sending means of the information, (3) sending the information via the sending means, and (4) storing the information on the system's database.

4. The method of claim 3, wherein the sending means is email.

5. The method of claim 3, wherein the sending means is a printer.

6. A computer implemented method of monitoring and completing an adoption service for an adoption applicant including the steps of:
providing a computer server and computer network;
storing adoption case information including a name of an adoption caseworker in a case database;
storing service benchmark data in a service phase database;
storing possible actions to be taken in an actions database;
storing document content associated with said actions in a document database;
storing adoption applicant records information in an applicant database;
assigning an ID number to an adoption applicant;
assigning said ID number to a caseworker file in said case database;
creating actions to be taken based on a phase of said service stored in said phase database and storing said actions in said actions database;
periodically polling said actions database for actionable items;
reviewing an actionable item to determine if the actionable item can be completed automatically and to find an ID number of the adoption applicant associated with the actionable item;
notifying, over said network, the adoption caseworker associated with said actionable items; and
sending correspondence about said actionable item to said applicant.

7. The method of claim 6, including the steps of:
receiving an email from said applicant and parsing said email message from said adoption applicant for key words including a name of the applicant, and summarizing the email message using key words.

8. The method of claim 7, wherein the actions taken are determined in part by the country of adoption.

9. The method of claim 6, wherein the actions taken are determined by the location of the applicant.

10. The method of claim 8, wherein the applicant is automatically sent a periodic update email while waiting for an adoption child to be identified and wherein said periodic update email ceases when an adoptive child is identified.
